(19) United States
(12) Patent Application Publication
(10) Pub. No.: US 2016/0305260 A1
(43) Pub. Date: Oct. 20, 2016

(54) BLADED WHEEL WITH SEPARABLE PLATFORM

(71) Applicant: Rolls-Royce North American Technologies, Inc., Indianapolis, IN (US)

(72) Inventor: Ted J. Freeman, Danville, IN (US)

(21) Appl. No.: 15/056,263

(22) Filed: Feb. 29, 2016

Related U.S. Application Data
(60) Provisional application No. 62/127,906, filed on Mar. 4, 2015.

(51) Int. Cl. F01D 5/30; F01D 5/28; F01D 11/00

(52) U.S. Cl. CPC F01D 5/3015; F01D 11/008; F01D 5/284; F05D 2220/32; F05D 2240/24; F05D 2240/55; F05D 2230/60; F05D 2260/30; F05D 2240/80

(57) ABSTRACT

A turbine wheel for use in a gas turbine engine having a plurality of blades attached to a rotor disk. The blades each include a root that fits within dovetail slots of the rotor disk to couple the blades to the rotor disk. A platform assembly is coupled to the rotor disk to surround the blades.

### CROSS REFERENCE TO RELATED APPLICATIONS

This application claims priority to and the benefit of U.S. Provisional Patent Application No. 62/127,906, filed 4 Mar. 2015, the disclosure of which is now expressly incorporated herein by reference.

### FIELD OF THE DISCLOSURE

The present disclosure relates generally to gas turbine engines, and more specifically to composite blade attachment.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

To withstand heat from the combustion products received from the combustor, the turbine may include blades made from ceramic-matrix composite materials that are able to interact with the hot combustion products. In some turbine wheels, the blades may be coupled to a metallic disk that supports the blades in a gas path leading out of the combustor. Coupling of the blades made from ceramic-matrix composite materials with metallic disks can present design challenges.

### SUMMARY

The present disclosure may comprise one or more of the following features and combinations thereof.

According to one aspect of the present disclosure, a turbine wheel for a gas turbine engine may include a disk, a blade, a platform assembly, and one or more seal members. The disk may be formed to include a dovetail slot that extends through the disk in a generally axial direction from a forward side to an aft side of the disk and inwardly in a radial direction from an outer diameter of the disk toward a central axis. The blade may comprise ceramic-containing materials and may be formed to include an airfoil that extends outwardly in the radial direction from the outer diameter of the disk and a root that extends into the dovetail slot to engage with the dovetail slot and couple the blade to the disk. The platform assembly may include two platform segments that include ceramic-containing materials coupled to the disk by pins extending axially through a portion of the platform segments and through a portion of the disk. The platforms segments may be positioned on opposing sides of the blade to at least partially define a flow path around the airfoil of the blade. The one or more seal members may comprise ceramic-containing materials and be positioned between the blade and the platform segments. The platforms segments may be engaged with the one or more seal members to block combustion products formed in the gas turbine engine from passing around the root of the blade.

In some embodiments, each of the platform segments may include a deck, a forward tab extending radially inward from the deck, and an aft tab spaced apart from the forward tab and extending radially inward from the deck. The pins may pass through the forward and aft tabs of the platform segments. The pins may comprise ceramic-containing materials. The pins may be substantially cylindrical. Additionally, in some embodiments, each pin may have an oblong profile along a length of the pin. A wider portion of the oblong profile may be arranged to extend in a generally circumferential direction around the disk. Additionally, in some embodiments, a wider portion of the oblong profile may be arranged to extend in a generally radial direction relative to the disk.

In some embodiments, each of the platform segments may include a deck, a forward tab extending radially inward from the deck, and an aft tab spaced apart from the forward tab and extending radially inward from the deck, and the one or more seal members may be positioned between the blade and the decks of the platform segments. The one or more seal members may include a first seal member positioned between one of the platform segments and the blade and a second seal member positioned between the other platform segment and the blade. Additionally, in some embodiments, each of the platform segments may include a first contoured edge formed to match an outer profile of a first side of the blade and a second contoured edge formed to match an outer profile of a second side of the blade. The seal member may include a first portion positioned between the first contoured edge of one of the platform segments and the first side of the blade and a second portion positioned between the second contoured edge of the other platform segment and the second side of the blade. The seal member may have a circular cross-sectional shape. Additionally, in some embodiments, the seal member may have a polygonal cross-sectional shape.

According to another aspect of the present disclosure, a turbine wheel for a gas turbine engine may include a disk, a blade, a platform assembly, and one or more seal members. The disk may be formed to include a dovetail slot that extends through the disk in a generally axial direction from a forward side to an aft side of the disk and inwardly in a radial direction from an outer diameter of the disk toward a central axis. The blade may be formed to include an airfoil that extends outwardly in the radial direction from the outer diameter of the disk and a root that extends into the dovetail slot to engage with the dovetail slot and couple the blade to the disk. The platform assembly may include two platform segments, and each platform segment may include a deck, a forward tab extending radially inward from the deck, and an aft tab spaced apart from the forward tab and extending radially inward from the deck. The platform segments may be positioned on opposing sides of the blade to at least partially define a flow path around the airfoil of the blade and coupled to the disk by pins extending axially through the forward tab, a portion of the disk, and the aft tab. The one or more seal members may comprise ceramic-containing materials and be positioned between the blade and the decks of the platform segments. The platform segments may be engaged with the one or more seal members to block combustion products formed in the gas turbine engine from passing around the root of the blade.

In some embodiments, the decks of the platform segments may each include a first edge extending between the forward tab and the aft tab and a second edge spaced apart from the first edge and extending between the forward tab and the aft tab, and the first edge may be formed to include a first seal-member receiver and the second edge may be formed to include a second seal-member receiver. The seal member may include a first portion positioned between the first edge of one of the decks and a first side of the blade within the first seal-member receiver and a second portion positioned between the second edge of the other deck and a second side of the blade within the second seal-member receiver. The seal member may have a circular cross-sectional shape. Additionally, in some embodiments, the seal member may have a polygonal cross-sectional shape.

According to yet another aspect of the present disclosure, a method of making a turbine wheel may comprise positioning a root of a blade in a dovetail slot of a rotor disk such that the root is positioned to engage the dovetail slot formed by the rotor disk to retain the blade in place relative to the rotor disk during rotation of the rotor disk. The method may further comprise positioning one or more seal members to surround and engage at least a portion of the blade. The method may further comprise positioning a first platform segment to surround at least a portion of the blade and engage at least a portion of the one or more seal members. The method may further comprise positioning a second platform segment to surround at least a portion of the blade and engage at least a portion of the one or more seal members. The method may further comprise positioning a first pin through the first platform segment and the rotor disk to couple the first platform segment with the rotor disk and positioning a second pin through the second platform segment and the rotor disk to couple the second platform segment with the rotor disk.

These and other features of the present disclosure will become more apparent from the following description of the illustrative embodiments.

### BRIEF DESCRIPTION OF THE DRAWINGS

FIG. 1 is a perspective view of a portion of a turbine wheel adapted for use in a gas turbine engine showing that the turbine wheel includes a rotor disk having a dovetail slot, a blade, and a platform assembly including a pair of platform segments coupled to the rotor disk and engaging with the blade to at least partially define a gas path through a turbine section of the gas turbine engine;

FIG. 2 is an exploded assembly view of the turbine wheel of FIG. 1 showing that the blade includes an airfoil and a root sized to engage with the dovetail slot to couple the blade with the rotor disk and showing that the platform segments are coupled to the rotor disk by pins extending through tabs of the platform segments and a body of the rotor disk;

FIG. 3 is a sectional view of the turbine wheel of FIG. 1 showing that a seal member is positioned between the platform segments and the blade and suggesting that the platform segments and blade are formed from ceramic-containing materials;

FIG. 4 is a detail view of the turbine wheel of FIG. 3 showing a first embodiment of a round seal member that is positioned between the platform segment and the blade that engages with the blade and platform segment to form a seal;

FIG. 5 is a detail view similar to FIG. 4 showing a second embodiment of a polygonal seal member that is positioned between the platform segment and the blade that engages with the blade and platform segment to form a seal;

FIG. 6 is a partial sectional view of one embodiment of a seal member in accordance with the present disclosure showing that the seal member has a polygonal cross-section;

FIG. 7 is a detail view similar to FIG. 4 showing that the blade is formed to include a recess positioned to receive a portion of the platform segment to form a seal between the blade and platform segment;

FIG. 8 is a partial sectional view of another turbine wheel adapted for use in the gas turbine engine showing that the turbine wheel includes a blade, a rotor disk having a dovetail slot for retaining the blade, and a platform assembly including a pair of platform segments coupled to the rotor disk by oblong pins having a wider portion arranged to extend in a generally circumferential direction around the rotor disk; and

FIG. 9 is a partial sectional view of another turbine wheel adapted for use in the gas turbine engine showing that the turbine wheel includes a blade, a rotor disk having a dovetail slot for retaining the blade, and a platform assembly including a pair of platform segments coupled to the rotor disk by oblong pins having a wider portion arranged to extend in a generally radial direction relative to the rotor disk.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

An illustrative turbine wheel 100 adapted for use in a gas turbine engine is shown in FIGS. 1-3. The turbine wheel 100 includes a rotor disk 102 (only a portion of which is shown), a plurality of turbine blades 104 (only one of which is shown), and a platform assembly 10 including a plurality of platform segments (only two platform segments 12, 14 are shown). In accordance with the present disclosure, the turbine blades 104 are attached to the rotor disk 102 for rotation with the rotor disk 102 about a central axis of the gas turbine engine. The platform assembly 10 directs combustion products produced by the gas turbine engine to flow around the blade 104.

Each blade 104 is formed to include a root 22 and an airfoil 24 coupled to the root 22 as shown, for example, in FIG. 2. Each blade 104 of the exemplary embodiment is made from a ceramic-matrix composite material adapted to withstand high temperature combustion products discharged onto the blade 104. The blades 104 illustratively comprise silicon-carbide reinforcements suspended in silicon-carbide matrix material. In other embodiments, other reinforcements and other ceramic-containing matrix materials may be included in the blades 104. In yet other embodiments, the blades 104 are formed from metallic materials.

The platform assembly 10 is coupled to the rotor disk 102 by pins 16, 18 and positioned to surround the blade 104 as shown in FIGS. 1 and 2. The platform assembly 10 defines at least a portion of a flow path to direct combustion products formed in a combustor over the blades 104 and through a turbine section of the gas turbine engine. Each platform segment 12, 14 of the exemplary embodiment is made from a ceramic-matrix composite material adapted to withstand high temperature combustion products discharged onto the platform assembly 10. The platform segments 12, 14 illustratively comprise silicon-carbide reinforcements suspended in silicon-carbide matrix material. In other embodiments, other reinforcements and other ceramic-containing matrix materials may be included in the platform segment 12, 14. In yet other embodiments, the platform segments 12, 14 are formed from metallic materials.

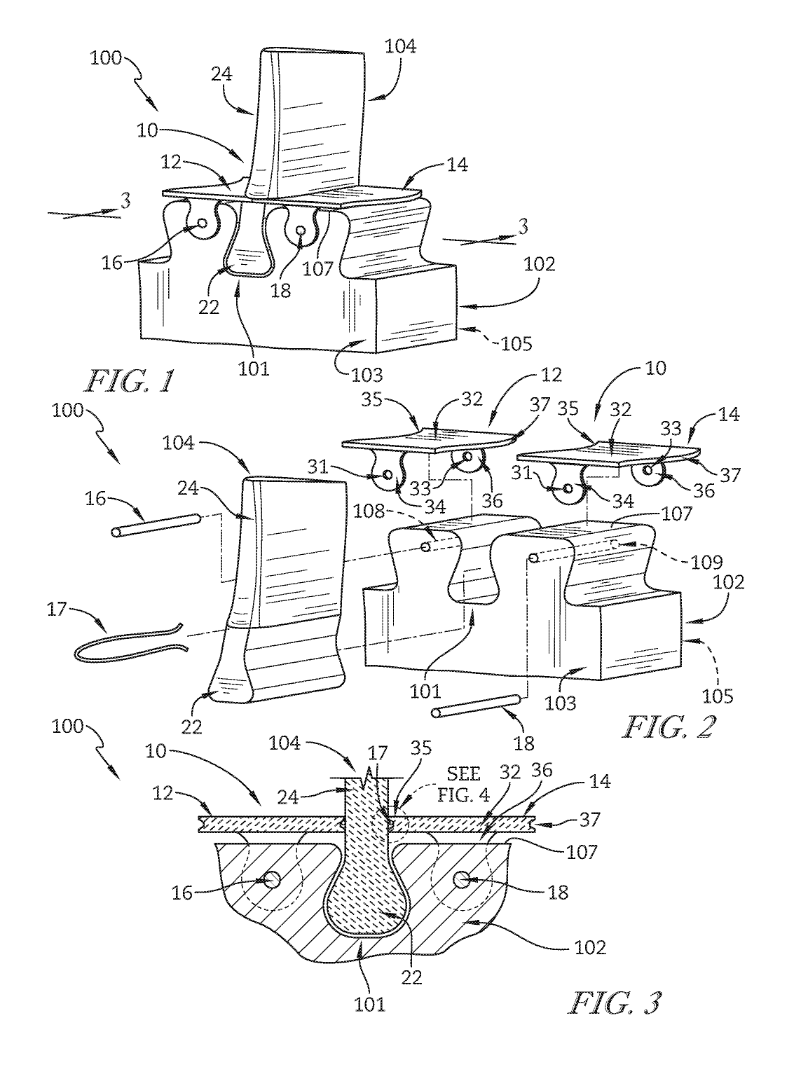

A seal member 17 is positioned to engage with the blade 104 as shown in FIGS. 2-3. The platform assembly 10 engages with the seal member 17 and separates the root 22 from the airfoil 24 of the blade 104 so that gasses passing over the airfoil 24 are blocked from moving down around the root 22 as suggested in FIGS. 1-3. The airfoil 24 of the blade 104 is aerodynamically shaped to interact with the combustion products moving over the blade 104 to rotate the turbine wheel 100 about the central axis of the gas turbine engine.

In the illustrative embodiment, the seal member 17 includes a first portion positioned between the platform segment 12 and the blade 104 and a second portion positioned between the platform segment 14 and the blade 104 as suggested in FIGS. 2 and 3. In some embodiments, separate seal members are positioned between the platform segments 12, 14 and the blade 104. The seal member 17 illustratively comprises silicon-carbide reinforcements suspended in silicon-carbide matrix material. In other embodiments, other reinforcements and other ceramic-containing matrix materials may be included in the seal member 17. In yet other embodiments, the seal member 17 is formed from metallic materials.

The rotor disk 102 is illustratively made from a metallic superalloy (e.g. Inconel, Waspaloy, etc.) and includes a forward side 103 facing toward a front of the gas turbine engine, an aft side 105 facing toward a rear of the engine, and a radial surface 107 defining an outer diameter (sometimes called the dead rim) of the rotor disk 102 as shown in FIGS. 1 and 2. The rotor disk 102 is additionally formed to include a plurality of dovetail slots 101 (only three of which are shown) formed in the rotor disk 102. In other embodiments, the rotor disk may be made from other metallic or non-metallic materials.

Each dovetail slot 101 extends inwardly in the radial direction from the radial surface 107 of the rotor disk 102 as shown in FIG. 2. Further, each dovetail slot 101 extends through the rotor disk 102 from the forward side 103 to the aft side 105 in a generally axial direction and is shaped to form a dovetail shape when viewed from the front or aft sides 103, 105. The dovetail slots 101 are positioned to couple the plurality of blades 104 to the rotor disk 102 to form the turbine wheel 100. The illustrative dovetail slots 101 extend in the axial direction but may also extend only generally axially such that a slot angle of up to about twenty-five degrees may be formed relative to the straight axial direction.

Each of the platform segments 12, 14 includes a deck 32, a forward tab 34 extending radially inward from the deck 32, and an aft tab 36 spaced apart from the forward tab 34 and extending radially inward from the deck 32 as shown in FIG. 2. The forward tabs 34 include an aperture 31 and the aft tabs 36 include an aperture 33. The rotor disk 102 is formed to include pin-receiving channels 108, 109 sized to receive the pins 16, 18, respectively.

The forward and aft tabs 34, 36 are positioned to align the apertures 31, 33 with the pin-receiving channels 108, 109 as shown in FIGS. 2 and 3. The forward and aft tabs 34, 36 are sized to space the decks 32 from the radial surface 107 of the rotor disk 102 when the pins 16, 18 are inserted through the apertures 31, 33 and pin-receiving channels 108, 109. In the illustrative embodiment, the pins 16, 18 are substantially cylindrical. The pins 16, 18 illustratively comprise metallic materials. In other embodiments, the pins 16, 18 comprise silicon-carbide reinforcements suspended in silicon-carbide matrix material. In yet other embodiments, other reinforcements and other ceramic-containing matrix materials may be included in the pins 16, 18.

The decks 32 are formed to include contoured edges 35, 37 extending axially along opposing sides of the decks 32 as shown in FIG. 2. The contoured edges 35, 37 are shaped to substantially match an outer profile of the blade 104. For example, the contoured edge 37 of the platform segment 12 matches with a first side of the blade 104 while the contoured edge 35 of the platform segment 14 matches with an opposite second side of the blade 104 such that the platform segments 12, 14 surround the blade 104 as suggested in FIG. 1

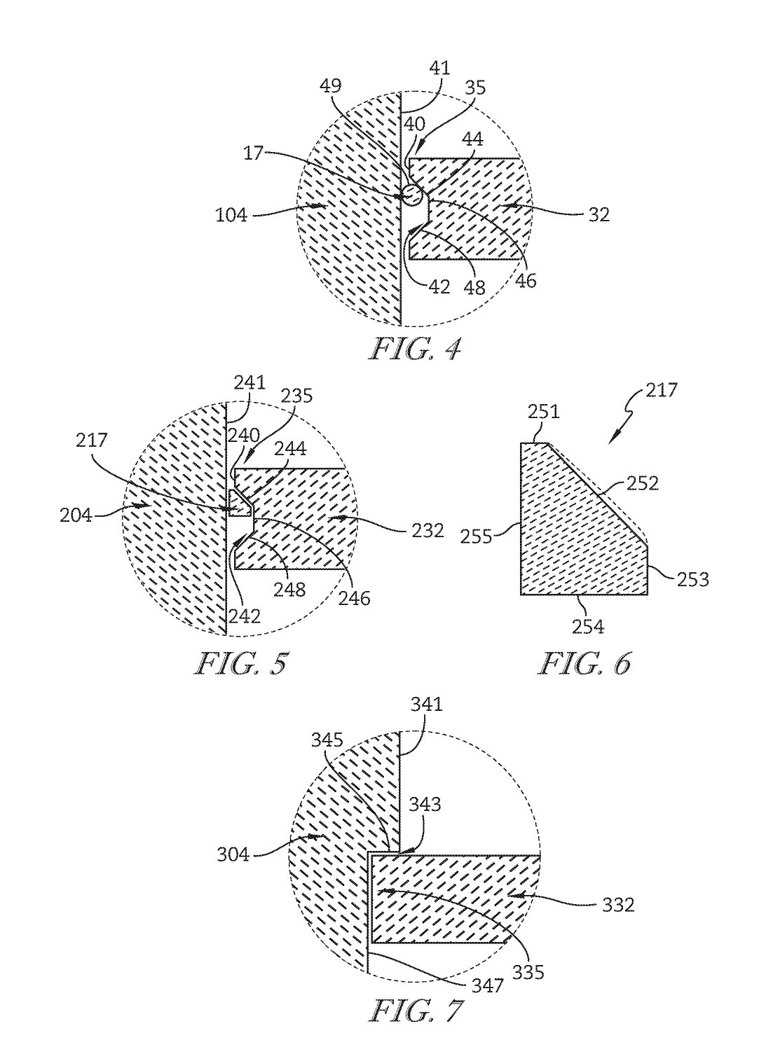

Each of the contoured edges 35, 37 are formed to include a seal-receiving channel 42 in a side surface 40 as illustratively shown by contoured edge 35 in FIG. 4. The seal-receiving channel 42 includes an outer-sloped surface 44, an inner-sloped surface 48, and a central surface 46 extending between the outer-sloped surface 44 and inner-sloped surface 48. The outer-sloped surface 44 and inner-sloped surface 48 extend into the deck 32 from the side surface 40 and converge toward one another. In some embodiments, the surfaces 44, 48 may not be sloped but rather may be a radius, a slope, or horizontal.

The side surfaces 40 of the decks 32 are spaced apart from an exterior surface 41 of the blade 104 when the platform segments 12, 14 are coupled to the rotor disk 102 as suggested in FIG. 4. Notably, the exterior surface 41 may be formed, at least in part, by an environmental barrier coating applied to the blade 104. The seal member 17 experiences centrifugal loading as the turbine wheel 100 rotates about the central axis of the gas turbine engine and is forced radially outward. The seal member 17 has a substantially circular cross-section defined by an outer surface 49. The outer surface 49 of the seal member 17 engages with the outer-sloped surface 44 of the seal-receiving channel 42 and the exterior surface 41 of the blade 104 to block combustion products from passing between the platform segments 12, 14 and the blade 104. The seal member 17 may also act as a damper and it may be that the pressure under the platform will be higher than the flowpath pressure so the seal member 17 will keep air from flowing form the underside of the platform to the flowpath. The lower-sloped surface 48 is positioned to block the seal member 17 from passing out of the seal-receiving channel 42 as rotation of the turbine wheel 100 slows.

In another embodiment, a seal member 217 is positioned within a seal-receiving channel 242 formed in a side surface 240 of a deck 232 as shown in FIG. 5. The deck 232 is included in a platform segment coupled to a rotor disk and positioned adjacent to a blade 204 coupled to the rotor disk. The side surface 240 is part of a contoured edge 235 of the deck 232.

The seal-receiving channel 242 includes an outer-sloped surface 244, an inner-sloped surface 248, and a central surface 246 extending between the outer-sloped surface 244 and inner-sloped surface 248 as shown in FIG. 5. The outer-sloped surface 244 and inner-sloped surface 248 extend into the deck 232 from the side surface 240 and converge toward one another. The side surface 240 is spaced apart from an exterior surface 241 of the blade 204 when the platform segment is coupled to the rotor disk.

The seal member 217 has a polygonal cross-section as shown in FIGS. 5 and 6. The seal member 217 includes an outer surface 251, an inner surface 254 spaced apart from the outer surface 251, and a contact surface 255 extending between the outer surface 251 and inner surface 254. A sloped surface 252 extends toward the inner surface 254 from the outer surface 251, and a spacer surface 253 extends between the sloped surface 252 and the inner surface 254. In some embodiments, the sloped surface 252 may be crowned (curved outwardly) as suggested in phantom in FIG. 6 to encourage engagement with other components. The surfaces 251, 252, 253, 254, 255 define the polygonal cross-section of the seal member 217.

The seal member 217 experiences centrifugal loading as the turbine wheel rotates about a central axis of a gas turbine engine and is forced radially outward as suggested in FIG. 5. The sloped surface 252 of the seal member 217 engages with the outer-sloped surface 244 of the seal-receiving channel 242 and the contact surface 255 engages with the exterior surface 41 of the blade 204 to block combustion products from passing between the deck 232 and the blade 204. The lower-sloped surface 248 of the seal-receiving channel 242 is positioned to block the seal member 217 from passing out of the seal-receiving channel 242 as rotation of the turbine wheel slows.

In another embodiment, a blade 304 is formed to include a recess 343 in an exterior surface 341 of the blade 304 as suggested in FIG. 7. The recess 343 includes an outer surface 345 extending into the blade 304 from the exterior surface 341 and a radial surface 347 extending radially inward from the outer surface 345. A contoured edge 335 included in a deck 332 cooperates with the outer surface 345 and radial surface 347 to define a labyrinth gap between the deck 332 and the blade 304. The labyrinth gap blocks combustion products from passing between the deck 332 and the blade 304. In some embodiments, a seal member (damper) like those described elsewhere herein may be captured between the blades 304 and decks 332 of platforms.

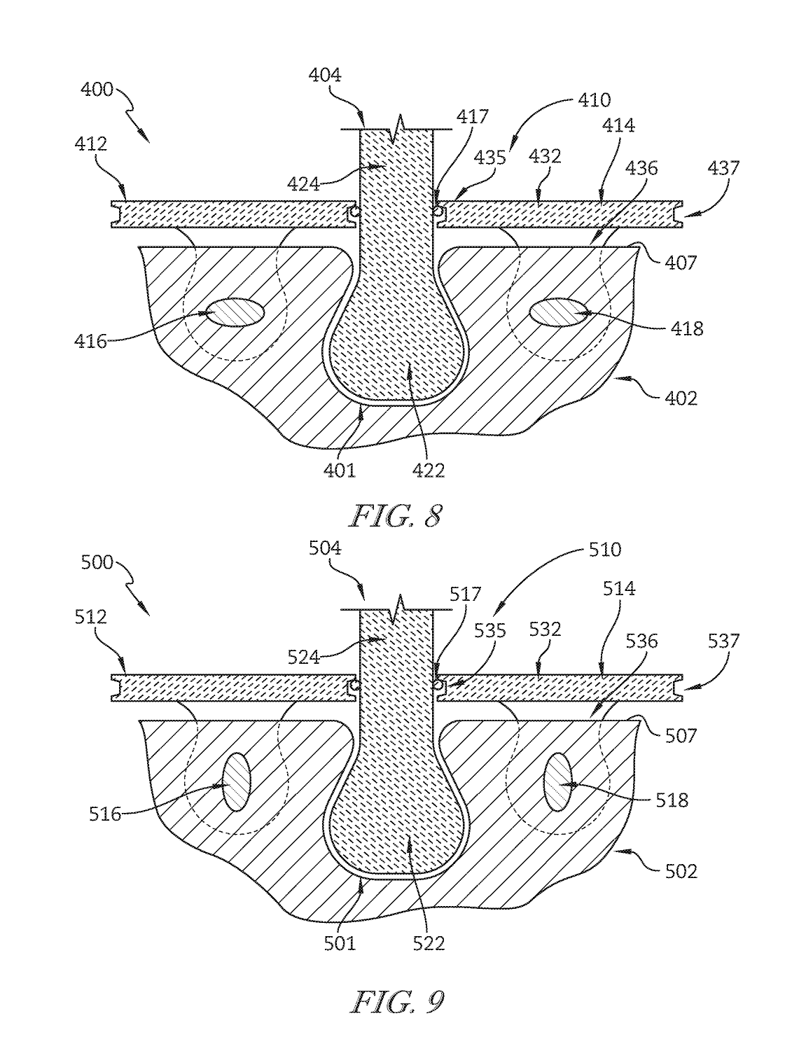

Another illustrative turbine wheel 400 adapted for use in a gas turbine engine is shown in FIG. 8. The turbine wheel 400 includes a rotor disk 402 (only a portion of which is shown), a plurality of turbine blades 404 (only one of which is shown), and a platform assembly 410 including a plurality of platform segments (only two platform segments 412, 414 are shown). In accordance with the present disclosure, the turbine blades 404 are attached to the rotor disk 402 for rotation with the rotor disk 402 about a central axis of the gas turbine engine. The platform assembly 410 directs combustion products produced by the gas turbine engine to flow around the blade 404.

Each blade 404 is formed to include a root 422 and an airfoil 424 coupled to the root 422 as shown in FIG. 8. Each blade 404 of the exemplary embodiment is made from a ceramic-matrix composite material adapted to withstand high temperature combustion products discharged onto the blade 404. The blades 404 illustratively comprise silicon-carbide reinforcements suspended in silicon-carbide matrix material. In other embodiments, other reinforcements and other ceramic-containing matrix materials may be included in the blades 404. In yet other embodiments, the blades 404 are formed from metallic materials.

The platform assembly 410 is coupled to the rotor disk 402 by pins 416, 418 and positioned to surround the blade 404 as shown in FIG. 8. The platform assembly 410 defines at least a portion of a flow path to direct combustion products formed in a combustor over the blades 404 and through a turbine section of the gas turbine engine. Each platform segment 412, 414 of the exemplary embodiment is made from a ceramic-matrix composite material adapted to withstand high temperature combustion products discharged onto the platform assembly 410. The platform segments 412, 414 illustratively comprise silicon-carbide reinforcements suspended in silicon-carbide matrix material. In other embodiments, other reinforcements and other ceramic-containing matrix materials may be included in the platform segment 412, 414. In yet other embodiments, the platform segments 412, 414 are formed from metallic materials.

A seal member 417 is positioned to engage with the blade 404 as shown in FIG. 8. The platform assembly 410 engages with the seal member 417 and separates the root 422 from the airfoil 424 of the blade 404 so that gasses passing over the airfoil 424 are blocked from moving down around the root 422. The airfoil 424 of the blade 404 is aerodynamically shaped to interact with the combustion products moving over the blade 404 to rotate the turbine wheel 400 about the central axis of the gas turbine engine.

In the illustrative embodiment, the seal member 417 includes a first portion positioned between the platform segment 412 and the blade 404 and a second portion positioned between the platform segment 414 and the blade 404 as suggested in FIG. 8. In some embodiments, separate seal members are positioned between the platform segments 412, 414 and the blade 404. The seal member 417 illustratively comprises silicon-carbide reinforcements suspended in silicon-carbide matrix material. In other embodiments, other reinforcements and other ceramic-containing matrix materials may be included in the seal member 417. In yet other embodiments, the seal member 417 is formed from metallic materials.

The rotor disk 402 is illustratively formed to include a plurality of dovetail slots 401 (only one of which is shown) formed in the rotor disk 402 that extends inwardly in the radial direction from a radial surface 407 of the rotor disk 402 as shown in FIG. 8. Further, each dovetail slot 401 extends through the rotor disk 402 from a forward side to an aft side and is shaped to form a dovetail shape when viewed from the front or aft sides. The dovetail slots 401 are positioned to couple the plurality of blades 404 to the rotor disk 402 to form the turbine wheel 400.

Each of the platform segments 412, 414 includes a deck 432 and one or more tabs 436 extending radially inward from the deck 432 as shown in FIG. 8. The pins 416, 418 are inserted through the tabs 436 and at least a portion of the rotor disk 402 to couple the platform segments 412, 414 with the rotor disk 402. The tabs 436 are sized to space the decks 432 from the radial surface 407 of the rotor disk 402 when the pins 416, 418 are inserted.

In the illustrative embodiment, the pins 416, 418 have an oblong exterior profile extending along their length as suggested in FIG. 8. The pins 416, 418 are arranged such that wider portion of the pins 416, 418 extend in a generally circumferential direction around the rotor disk 402. The pins 416, 418 illustratively comprise metallic materials. In other embodiments, the pins 416, 418 comprise silicon-carbide reinforcements suspended in silicon-carbide matrix material. In yet other embodiments, other reinforcements and other ceramic-containing matrix materials may be included in the pins 416, 418.

The decks 432 are formed to include contoured edges 435, 437 extending axially along opposing sides of the decks 432 as suggested in FIG. 8. The contoured edges 435, 437 are shaped to substantially match an outer profile of the blade 404. For example, the contoured edge 437 of the platform segment 412 matches with a first side of the blade 404 while the contoured edge 435 of the platform segment 414 matches with an opposite second side of the blade 404 such that the platform segments 412, 414 surround the blade 404.

Another illustrative turbine wheel 500 adapted for use in a gas turbine engine is shown in FIG. 9. The turbine wheel 500 includes a rotor disk 502 (only a portion of which is shown), a plurality of turbine blades 504 (only one of which is shown), and a platform assembly 510 including a plurality of platform segments (only two platform segments 512, 514 are shown). In accordance with the present disclosure, the turbine blades 504 are attached to the rotor disk 502 for rotation with the rotor disk 502 about a central axis of the gas turbine engine. The platform assembly 510 directs combustion products produced by the gas turbine engine to flow around the blade 504.

Each blade 504 is formed to include a root 522 and an airfoil 524 coupled to the root 522 as shown in FIG. 9. Each blade 504 of the exemplary embodiment is made from a ceramic-matrix composite material adapted to withstand high temperature combustion products discharged onto the blade 504. The blades 504 illustratively comprise silicon-carbide reinforcements suspended in silicon-carbide matrix material. In other embodiments, other reinforcements and other ceramic-containing matrix materials may be included in the blades 504. In yet other embodiments, the blades 504 are formed from metallic materials.

The platform assembly 510 is coupled to the rotor disk 502 by pins 516, 518 and positioned to surround the blade 504 as shown in FIG. 9. The platform assembly 510 defines at least a portion of a flow path to direct combustion products formed in a combustor over the blades 504 and through a turbine section of the gas turbine engine. Each platform segment 512, 514 of the exemplary embodiment is made from a ceramic-matrix composite material adapted to withstand high temperature combustion products discharged onto the platform assembly 510. The platform segments 512, 514 illustratively comprise silicon-carbide reinforcements suspended in silicon-carbide matrix material. In other embodiments, other reinforcements and other ceramic-containing matrix materials may be included in the platform segment 512, 514. In yet other embodiments, the platform segments 512, 514 are formed from metallic materials.

A seal member 517 is positioned to engage with the blade 504 as shown in FIG. 9. The platform assembly 510 engages with the seal member 517 and separates the root 522 from the airfoil 524 of the blade 504 so that gasses passing over the airfoil 524 are blocked from moving down around the root 522. The airfoil 524 of the blade 504 is aerodynamically shaped to interact with the combustion products moving over the blade 504 to rotate the turbine wheel 500 about the central axis of the gas turbine engine.

In the illustrative embodiment, the seal member 517 includes a first portion positioned between the platform segment 512 and the blade 504 and a second portion positioned between the platform segment 514 and the blade 504 as suggested in FIG. 9. In some embodiments, separate seal members are positioned between the platform segments 512, 514 and the blade 504. The seal member 517 illustratively comprises silicon-carbide reinforcements suspended in silicon-carbide matrix material. In other embodiments, other reinforcements and other ceramic-containing matrix materials may be included in the seal member 517. In yet other embodiments, the seal member 517 is formed from metallic materials.

The rotor disk 502 is illustratively formed to include a plurality of dovetail slots 501 (only one of which is shown) formed in the rotor disk 502 that extends inwardly in the radial direction from a radial surface 507 of the rotor disk 502 as shown in FIG. 9. Further, each dovetail slot 501 extends through the rotor disk 502 from a forward side to an aft side and is shaped to form a dovetail shape when viewed from the front or aft sides. The dovetail slots 501 are positioned to couple the plurality of blades 504 to the rotor disk 502 to form the turbine wheel 500.

Each of the platform segments 512, 514 includes a deck 532 and one or more tabs 536 extending radially inward from the deck 532 as shown in FIG. 9. The pins 516, 518 are inserted through the tabs 536 and at least a portion of the rotor disk 4502 to couple the platform segments 512, 514 with the rotor disk 502. The tabs 536 are sized to space the decks 532 from the radial surface 507 of the rotor disk 502 when the pins 516, 518 are inserted.

In the illustrative embodiment, the pins 516, 518 have an oblong exterior profile extending along their length as suggested in FIG. 9. The pins 516, 518 are arranged such that wider portion of the pins 516, 518 extend in a generally radial direction relative to the rotor disk 502. The pins 516, 518 illustratively comprise metallic materials. In other embodiments, the pins 516, 518 comprise silicon-carbide reinforcements suspended in silicon-carbide matrix material. In yet other embodiments, other reinforcements and other ceramic-containing matrix materials may be included in the pins 516, 518.

The decks 532 are formed to include contoured edges 535, 537 extending axially along opposing sides of the decks 532 as suggested in FIG. 9. The contoured edges 535, 537 are shaped to substantially match an outer profile of the blade 504. For example, the contoured edge 537 of the platform segment 512 matches with a first side of the blade 504 while the contoured edge 535 of the platform segment 514 matches with an opposite second side of the blade 504 such that the platform segments 512, 514 surround the blade 504.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine wheel for a gas turbine engine, the turbine wheel comprising
a disk formed to include a slot that extends through the disk in a generally axial direction from a forward side to an aft side of the disk and inwardly in a radial direction from an outer diameter of the disk toward a central axis,
a blade comprising ceramic-containing materials, the blade formed to include an airfoil that extends outwardly in the radial direction from the outer diameter of the disk and a root that extends into the slot and engages the disk to couple the blade to the disk,
a platform assembly including two platform segments comprising ceramic-containing materials coupled to the disk by pins extending axially through a portion of the platform segments and through a portion of the disk, the platform segments positioned on opposing sides of the blade to at least partially define a flow path around the airfoil of the blade, and
one or more seal members positioned between the blade and the platform segments, the platform segments engaging with the one or more seal members to block combustion products formed in the gas turbine engine from passing around the root of the blade.

2. The turbine wheel of claim 1, wherein each of the platform segments includes a deck, a forward tab extending radially inward from the deck, and an aft tab spaced apart from the forward tab and extending radially inward from the deck.

3. The turbine wheel of claim 2, wherein the pins pass through the forward and aft tabs of the platform segments.

4. The turbine wheel of claim 3, wherein the pins comprise metallic materials.

5. The turbine wheel of claim 4, wherein the pins are substantially cylindrical.

6. The turbine wheel of claim 4, wherein each pin has an oblong profile along a length of the pin.

7. The turbine wheel of claim 6, wherein a wider portion of the oblong profile is arranged to extend in a generally circumferential direction around the disk.

8. The turbine wheel of claim 6, wherein a wider portion of the oblong profile is arranged to extend in a generally radial direction relative to the disk.

9. The turbine wheel of claim 2, wherein the one or more seal members are positioned between the blade and the decks of the platform segments.

10. The turbine wheel of claim 9, wherein the one or more seal members includes a first seal member positioned between one of the platform segments and the blade and a second seal member positioned between the other platform segment and the blade.

11. The turbine wheel of claim 9, wherein each of the platform segments include a first contoured edge formed to match an outer profile of a first side of the blade and a second contoured edge formed to match an outer profile of a second side of the blade.

12. The turbine wheel of claim 11, wherein the seal member includes a first portion positioned between the first contoured edge of one of the platform segments and the first side of the blade and a second portion positioned between the second contoured edge of the other platform segment and the second side of the blade.

13. The turbine wheel of claim 12, wherein the seal member has a circular cross-sectional shape.

14. The turbine wheel of claim 12, wherein the seal member has a polygonal cross-sectional shape.

15. A turbine wheel for a gas turbine engine, the turbine wheel comprising
a disk formed to include a slot that extends through the disk in a generally axial direction from a forward side to an aft side of the disk and inwardly in a radial direction from an outer diameter of the disk toward a central axis,
a blade formed to include an airfoil that extends outwardly in the radial direction from the outer diameter of the disk and a root that extends into the slot engaging the disk to couple the blade to the disk,
a platform assembly including two platform segments, each platform segment including a deck, a forward tab extending radially inward from the deck, and an aft tab spaced apart from the forward tab and extending radially inward from the deck, the platform segments positioned on opposing sides of the blade to at least partially define a flow path around the airfoil of the blade and coupled to the disk by pins extending axially through the forward tab, a portion of the disk, and the aft tab, and
one or more seal members comprising ceramic-containing materials and positioned between the blade and the decks of the platform segments, the platform segments engaging with the one or more seal members to so that the seal members act as dampers between the blade and the platform assembly.

16. The turbine wheel of claim 15, wherein the decks of the platform segments each include a first edge extending between the forward tab and the aft tab and a second edge spaced apart from the first edge and extending between the forward tab and the aft tab, and wherein the first edge is formed to include a first seal-member receiver and the second edge is formed to include a second seal-member receiver.

17. The turbine wheel of claim 16, wherein the seal member includes a first portion positioned between the first edge of one of the decks and a first side of the blade within the first seal-member receiver and a second portion positioned between the second edge of the other deck and a second side of the blade within the second seal-member receiver.

18. The turbine wheel of claim 17, wherein the seal member has a circular cross-sectional shape.

19. The turbine wheel of claim 17, wherein the seal member has a polygonal cross-sectional shape.

20. A method of making a turbine wheel, the method comprising
positioning a root of a blade in a dovetail slot of a rotor disk such that the root is positioned to engage the dovetail slot formed by the rotor disk to retain the blade in place relative to the rotor disk during rotation of the rotor disk,
positioning one or more seal members to surround and engage at least a portion of the blade,
positioning a first platform segment to surround at least a portion of the blade and engage at least a portion of the one or more seal members,
positioning a second platform segment to surround at least a portion of the blade and engage at least a portion of the one or more seal members, and
positioning a first pin through the first platform segment and the rotor disk to couple the first platform segment with the rotor disk and positioning a second pin through the second platform segment and the rotor disk to couple the second platform segment with the rotor disk.
